(19) United States
(12) Patent Application Publication
(10) Pub. No.: US 2026/0183789 A1
(43) Pub. Date: Jul. 2, 2026

(54) APPARATUS AND METHOD FOR COATING A PORTION, IN PARTICULAR A CHAMFER AND/OR AN END FACE, OF A PLANAR WORKPIECE WITH A COATING MEDIUM

(71) Applicant: JOSEF SCHIELE, Niederzissen (DE)

(72) Inventors: Matthias Gros, Niederzissen (DE); Stefan Schiele, Niederzissen (DE)

(21) Appl. No.: 18/863,808

(22) PCT Filed: May 3, 2023
(86) PCT No.: PCT/EP2023/061615

§ 371 Date: Nov. 7, 2024

(30) Foreign Application Priority Data
May 11, 2022 (DE) 102022204635.8

(51) Int. Cl. B05C 9/12; B05C 5/02; B05C 11/06

(52) U.S. Cl. CPC B05C 9/12; B05C 5/0204; B05C 11/06

(57) ABSTRACT

The present invention relates to an apparatus (1) for coating a portion, in particular a chamfer and/or an end face, of a planar workpiece with a coating medium, the apparatus comprising a coating unit (2) which has an application device (3) and a blow-off device (4) which are arranged such that the portion of the workpiece to be coated can be moved along first to the application device (2) and then to the blow-off device (3), wherein a negative pressure can be generated in a negative pressure region (8) of the coating unit (2), wherein the application device (3) has a coating medium supply (9) for supplying the coating medium to an application region (10) in which the coating medium can be applied to the portion of the workpiece by means of the negative pressure in the negative pressure region (8), wherein the blow-off device (4) has at least one blow-off nozzle (13) through which a gas, in particular air, can be blown onto the workpiece in order to blow applied coating medium off the workpiece into the negative pressure region (8) and thereby adjust a layer thickness of the coating medium on the workpiece, wherein the blow-off device (4) has an air intake opening (14) through which additional air from outside the coating unit (2) can flow in during blowing using the blow-off nozzle (13) in order to generate an air flow between the workpiece and the negative pressure region (8) and to reduce unwanted deposits of coating medium on the workpiece.

The present invention relates to an apparatus for coating a portion, in particular a chamfer and/or an end face, of a planar workpiece with a coating medium. The invention further relates to a method for coating a portion, in particular a chamfer and/or an end face, of a planar workpiece with a coating medium.

Apparatuses for coating chamfers or end faces of planar workpieces, for example flooring elements or door leaves, are known from the prior art. Such apparatuses typically comprise a coating unit past which the workpiece to be coated is moved. In known coating units, the coating medium is conveyed into a nozzle. A negative pressure is usually generated in the region around the nozzle, which sucks the coating medium in while delivering it onto the workpiece. The coating medium layer thickness achieved on the workpiece may in this case be adjusted by the selection of the negative pressure applied.

A disadvantage which has been found is that a relatively high negative pressure is often required in order to achieve the desired layer thickness. However, a high negative pressure exerts a high shear stress on the coating medium, which may lead to poor-quality layers of the workpiece in question.

Against this background, the object is to reduce the shear stress on the coating medium.

In order to achieve the object, an apparatus for coating a portion, in particular a chamfer and/or an end face, of a planar workpiece with a coating medium is proposed,
having a coating unit, which comprises an application device and a blowing device that are arranged in such a way that the portion to be coated of the workpiece can be moved first along the application device and then along the blowing device,
wherein a negative pressure can be generated in a negative pressure region of the coating unit,
wherein the application device comprises a coating medium feed for supplying the coating medium to an application region in which the coating medium can be applied onto the portion of the workpiece by means of the negative pressure existing in the negative pressure region,
wherein the blowing device comprises at least one blowing nozzle through which a gas, in particular air, can be blown onto the workpiece in order to blow applied coating medium off from the workpiece into the negative pressure region and thereby to adjust a layer thickness of the coating medium on the workpiece,
wherein the blowing device comprises an air intake opening via which additional air from outside the coating unit can flow in during the blowing with the blowing nozzle in order to generate an air flow between the workpiece and the negative pressure region and to reduce undesired deposits of coating medium on the workpiece.

In the apparatus according to the invention, a blowing device is provided in addition to the application device as part of the coating unit. This combination offers the advantage that the adjustment of the layer thickness of the coating medium on the workpiece does not need to be carried out by the negative pressure in the coating unit, but may be carried out by the blowing device. Consequently, the negative pressure in the negative pressure region of the coating unit may be reduced so that the coating medium is exposed to a lower shear stress. Further, reducing the negative pressure also makes it possible to reduce the volume of air that is sucked through the coating unit. Overall, by this measure the entire apparatus may be made smaller and more compact than apparatuses known in the prior art. The layer thickness of the coating medium on the workpiece may be adjusted by the selection of the blowing pressure of the at least one blowing nozzle. To this extent, the workpiece may be smoothly coated by means of the at least one blowing nozzle. During operation of the at least one blowing nozzle, air from outside the coating unit may be taken in through the air intake opening of the blowing device. This can prevent coating medium that has accumulated in the negative pressure region from being sucked in by a Venturi effect caused by the blowing nozzle and being deposited in undesired regions of the workpiece.

The at least one blowing nozzle of the blowing device is, in particular, aligned in such a way that the air ejected by the blowing nozzle flows in the direction of the negative pressure region of the coating unit. Particularly preferably, the at least one blowing unit is aligned in such a way that the air expelled by the blowing nozzle flows in an intake direction in which air is taken in from the negative pressure region. Preferably, the blowing device comprises a plurality of blowing nozzles through which a gas, in particular air, can be blown onto the workpiece in order to blow applied coating medium off from the workpiece into the negative pressure region and thereby to adjust the layer thickness of the coating medium on the workpiece. The plurality of blowing nozzles are preferably arranged in such a way that a workpiece moved along the coating unit passes them successively. To this extent, compressed air may be applied sequentially to the same region of the workpiece through the plurality of nozzles.

According to one advantageous embodiment of the invention, the blowing device comprises an air intake channel which extends into an internal space of the coating unit, particularly into the negative pressure region, and which opens in the air intake opening. The flow profile of the air taken in from outside the coating unit may be defined by the channel. In addition, the air intake channel may have a wall which additionally shields the workpiece from the negative pressure region so that the protection against undesired suction of coating medium in from the negative pressure region of the coating unit is further improved.

According to one advantageous embodiment of the invention, the air intake channel forms a projection in the internal space, particularly in the negative pressure region. By the projection, particularly good shielding may be achieved against coating medium being sucked in. Any coating medium possibly sucked in can adhere to the projection and does not reach the workpiece.

According to one advantageous embodiment of the invention, the coating medium feed is arranged above the negative pressure region in the coating unit. In such an embodiment, the coating medium can be sucked downward out of the coating medium feed and thereby be applied onto the workpiece.

According to one advantageous embodiment of the invention, the coating medium feed is arranged below the negative pressure region in the coating unit. In such an embodiment, the coating medium can be sucked upward out of the coating medium feed and thereby be applied onto the workpiece. Preferably, the coating medium feed is arranged both above and below the negative pressure region so that the advantages of both variants of the supply of coating medium to the workpiece are combined.

According to one advantageous embodiment of the invention, the coating medium feed comprises a plurality of feed channels which open in the application region. The plurality of feed channels may be arranged next to one another in such a way that a workpiece moved along the coating unit passes them successively. To this extent, coating medium may be applied sequentially to the same region of the workpiece through the plurality of feed channels.

Preferably, the coating medium feed comprises a nozzle. The nozzle may be a flat nozzle. Particularly preferably, the coating medium feed comprises a plurality of nozzles, for example a plurality of flat nozzles. The nozzles may be arranged at the end of a feed channel.

According to one advantageous embodiment, the coating medium feed comprises at least one feed channel which is formed as an upwardly open recess in the application region, the feed channel preferably reaching as far as a front plate of the coating unit.

Preferably, the coating medium feed comprises a plurality of feed channels which are formed as upwardly open recesses in the application region, the feed channels preferably reaching as far as a front plate of the coating unit and being arranged next to one another.

According to one advantageous embodiment of the invention, the apparatus comprises a transport means for transporting the workpiece along the coating unit, the transport means being adapted to move the workpiece first along the application device and then along the blowing device. The transport means may be configured as a conveyor belt or as a conveyor chain.

According to one advantageous embodiment of the invention, at least one wearing element, in particular a wearing plate, which delimits the application region and is releasably connected to the outer contour, is arranged on an outer contour of the coating unit. The at least one wearing element may be removed from the coating unit if it is worn or frayed and replaced by another, in particular identically configured wearing element. Preferably, a plurality of wearing elements are provided. The workpiece may be brought in contact with the at least one wearing element, particular guided on it, during the coating in the system. To this extent, the at least one wearing element may act in the manner of a stop and contribute to a plurality of successively coated workpieces each being provided with the coating medium in the same portion of the workpiece in question. Preferably, the wearing element is matched to the contour of the workpiece to be coated. The at least one wearing element may be formed from a tempered steel or a hard metal or a ceramic. The production of the at least one wearing element may take place by a machining or additive manufacturing method.

According to one advantageous embodiment of the invention, the coating unit comprises a wall in which a cooling channel for conducting a coolant is arranged. The coating unit and/or the coating medium may be thermally regulated, in particular cooled, by the cooling channel. This may enable good processability of the coating medium and reduce the risk of undesired adhesion or drying of the coating medium inside the coating unit.

In order to achieve the object mentioned in the introduction, a method for coating a portion, in particular a chamfer and/or an end face, of a planar workpiece with a coating medium is further proposed,
wherein the portion to be coated of the workpiece is moved first along an application device and then along a blowing device of a coating unit,
wherein a negative pressure is generated in a negative pressure region of the coating unit,
wherein the coating medium is supplied via a coating medium feed of the application device to an application region in which the coating medium is applied onto the portion of the workpiece by means of the negative pressure existing in the negative pressure region,
wherein a gas, in particular air, is blown onto the workpiece through at least one blowing nozzle of the blowing device in order to blow applied coating medium off from the workpiece into the negative pressure region and thereby to adjust a layer thickness of the coating medium on the workpiece,
wherein additional air from outside the coating unit flows in through an intake opening of the blowing device during the blowing with the blowing nozzle in order to generate an air flow between the workpiece and the negative pressure region and to reduce undesired deposits of coating medium on the workpiece.

With the method according to the invention, the same effects and advantages may be achieved as already described in connection with the apparatus according to the invention.

According to one advantageous embodiment of the method, the gas is blown through the blowing nozzle onto the workpiece with a pressure in the range of from 0.05 bar to 4 bar, preferably in the range of from 0.1 bar to 1 bar. The layer thickness of the coating medium on the workpiece may be adjusted by adjusting the pressure of the blowing nozzle. The pressure range indicated has been found to be advantageous for adjusting technically relevant layer thicknesses.

According to one advantageous embodiment of the method, the gas, in particular the air, is humidified, in particular with a water mist, before being blown out from the blowing nozzle. For example, the gas may be exposed to the water mist. The humidifying may be carried out in a humidifying apparatus which is configured in the manner of a compressed air oiler, with the difference that the gas is exposed to a water mist instead of an oil mist.

According to one advantageous embodiment of the method, the negative pressure in the coating unit is in the range of from 10 mbar to 250 mbar, preferably in the range of from 15 mbar to 40 mbar. By the combination of a blowing device and application device in a common coating unit, it is possible to set the negative pressure in the coating unit to be low in comparison with the prior art but nevertheless apply thin layer thicknesses that are customary in the art. The negative pressure ranges mentioned been found to be advantageous in practice.

According to one advantageous embodiment of the method, a temperature of the coating unit is adjusted to the dew point. Such adjustment of the temperature is advantageous in particular when using a water-based coating medium, in order to avoid undesired adhesions or deposits of coating medium inside the coating unit.

According to one advantageous embodiment of the method, the ambient air surrounding the coating unit is humidified, in particular humidified in such a way that the dew point lies above a minimum processing temperature of the coating medium. Such humidifying of the ambient air is advantageous in particular when using a water-based coating medium, in order to avoid undesired adhesions or deposits of coating medium inside the coating unit and/or in the region of the coating medium feed of the application device.

Alternatively or in addition to the advantageous embodiments explained above, the advantageous embodiments and features explained in connection with the apparatus according to the invention may be used in the method.

The device explained above and the method explained above are particularly advantageously suitable for the coating of flooring elements, in particular floorboards. During the coating of flooring elements, a decorative surface may preferably be oriented downward while an end face and/or a chamfer of the flooring element is moved along the coating unit in order to coat the end face and/or the chamfer.

Further details and advantages of the invention will be explained below with the aid of the exemplary embodiments shown in the figures, in which:

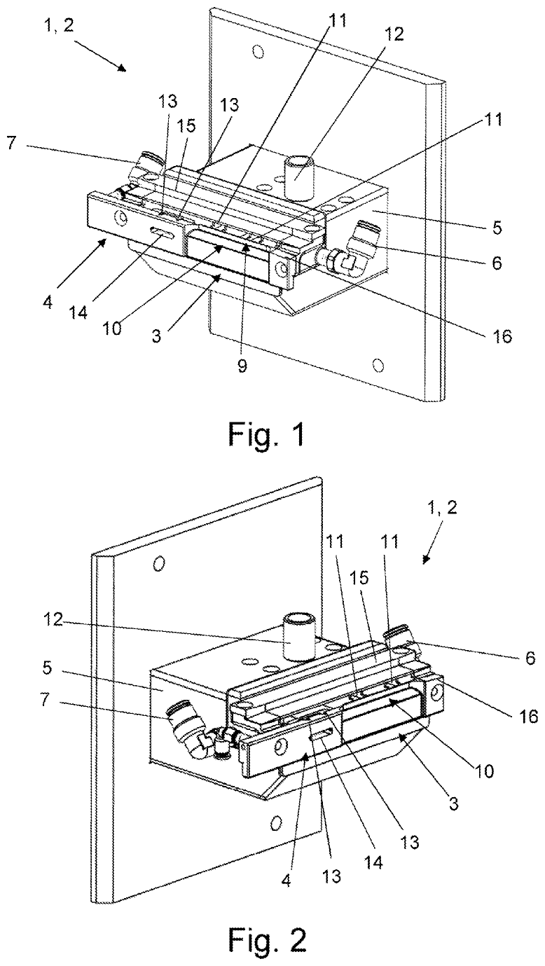

FIG. 1 shows a coating unit according to one exemplary embodiment of the invention in a first perspective representation;

FIG. 2 shows the coating unit according to FIG. 1 in a second perspective representation;

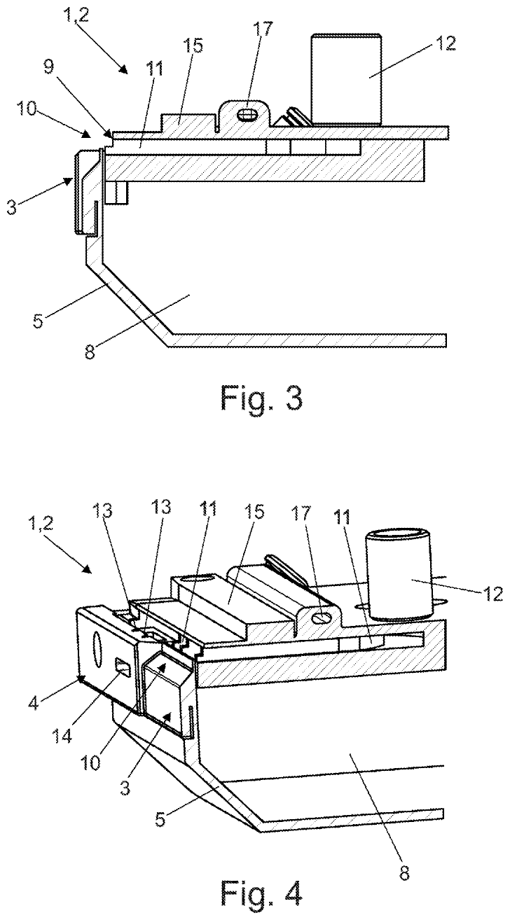

FIG. 3 shows the application device of the coating unit according to FIG. 1 in a sectional representation;

FIG. 4 shows the application device according to FIG. 3 in a perspective sectional representation; side view;

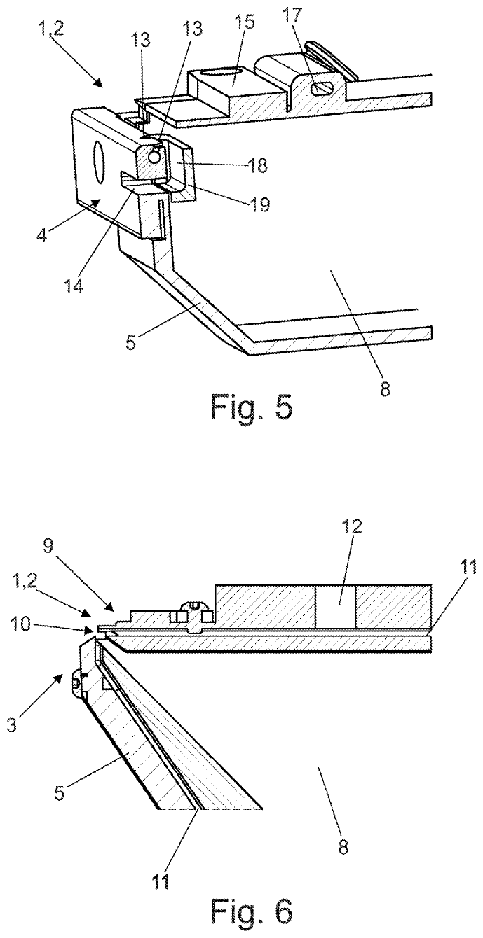

FIG. 5 shows the blowing device of the coating unit according to FIG. 1 in a perspective sectional representation; and

FIG. 6 shows an application device of a coating unit according to a further exemplary embodiment of the invention in a sectional representation.

The representation in FIGS. 1 and 2 shows an apparatus 1 for coating a portion, in particular a chamfer and/or an end face, of a planar workpiece with a coating medium according to a first exemplary embodiment of the invention. The apparatus 1 comprises a coating unit 2. The workpieces to be coated are configured as flooring elements, in particular floorboards. During the coating of flooring elements, a decorative surface may preferably be oriented downward while an end face and/or a chamfer of the flooring elements is turned toward the coating unit and is moved along the latter in order to coat the end face and/or the chamfer.

The coating unit 2 comprises an application device 3 and a blowing device 4, which are arranged next to one another. By this arrangement, the portion to be coated of the workpiece may be moved first along the application device 3 and then along the blowing device 4. Coating medium may therefore first be applied onto the portion of the workpiece and then the coating medium may be blown off in order to adjust a desired layer thickness on the portion of the workpiece.

The coating unit 2 comprises a common housing 5 for the application device 3 and a blowing device 4. The housing 5 comprises walls through which one or more cooling channels extend. The cooling channels are fluidically connected to coolant connections 6, 7 through which coolant can be supplied to the cooling channels and discharged therefrom. By means of the cooling channels, a temperature of the coating unit 2 that corresponds to the dew point is preferably adjusted.

Provided inside the housing 5, there is a negative pressure region 8 in which a negative pressure is generated, for example by a vacuum pump arranged outside the housing 5. For this purpose, the housing may comprise an opening to which a vacuum pump can be attached. In FIGS. 1 and 2, this opening is arranged on the rearward side of the housing 5, which cannot be seen.

The application device 3 of the coating unit 2 comprises a coating medium feed 9 for supplying the coating medium to an application region 10 in which the coating medium can be applied onto the portion of the workpiece by means of the negative pressure existing in the negative pressure region 8. In the exemplary embodiment according to FIGS. 1 and 2, the coating medium feed 9 comprises two feed channels 11 which are supplied from a coating medium inlet 12. The feed channels 11 are arranged above the negative pressure region 8 inside the housing 5.

In the exemplary embodiment, the feed channels 11 are formed as upwardly open recesses in the application region 10, which are arranged next to one another and reach as far as a front plate of the coating unit 2.

The blowing device 4 comprises at least one, here two blowing nozzles 13 through which a gas, in particular air, can be blown onto the workpiece in order to blow applied coating medium off from the workpiece into the negative pressure region 8 and thereby to adjust a layer thickness of the coating medium on the workpiece. The blowing nozzles 13 are integrated into the outer contour of the coating unit 2 in such a way that first the workpiece can be supplied with the coating medium in the application region 10 by the interaction of the coating medium feed 9 and the negative pressure region 8 and then excess coating medium is blown off by the blowing nozzles 13. The gas, in particular the air, is preferably blown through the blowing nozzle onto the workpiece with a pressure in the range of from 0.05 bar to 4 bar, preferably in the range of from 0.3 bar to 2 bar, particularly preferably in the range of from 0.1 bar to 1 bar. The gas may be humidified before the blowing. Alternatively or in addition, the ambient air of the coating unit 2 may be humidified, particularly in such a way that the dew point lies above a minimum processing temperature of the coating medium.

It is further provided that the blowing device 4 comprises an air intake opening 14 via which additional air from outside the coating unit 2 can flow in during the blowing with the blowing nozzles 13. In this way, an air flow is generated between the workpiece and the negative pressure region 8 and undesired deposits of the coating medium on the workpiece are reduced, or prevented. As represented in FIGS. 1 and 2, the air intake opening 14 lies in the region below the two blowing nozzles 13 so that the air flow is generated below the workpiece. In the exemplary embodiment, the air intake opening 14 is configured in the manner of an elongate hole. As a variant of this, the air intake opening 14 may however also have a different cross section and/or a plurality of air intake openings may be provided.

The apparatus 1 further comprises a transport means (not represented in the drawings) for transporting the workpiece along the coating unit 2. By means of the transport means, the workpiece can be moved first along the application device 3 and then along the blowing device 4 in order first to apply coating medium onto the respective portion of the workpiece and then to smoothly coat it, or adjust the desired layer thickness. The transport means may be configured as a conveyor belt or as a conveyor chain.

Further, a plurality of wearing elements 15, 16 are arranged on the outer contour of the coating unit 2. The wearing elements 15, 16 are arranged releasably on the outer contour, for example by means of screw connections, so that they can be removed and replaced in the event of excessive fraying or fouling. By the releasable attachment, it is furthermore possible for wearing elements 15, 16 that are adapted to the workpiece to be fastened on the coating unit 2 as a function of the workpiece to be coated.

The representations in FIGS. 3 and 4 show the application device 3 of the coating unit 2 in sectional representations. It may be seen that the coating medium feed 9 is arranged above the negative pressure region 8 in the coating unit 2 so that the coating medium is sucked downward out of the coating medium feed 9 and is thereby applied onto the workpiece. In the exemplary embodiment, the coating medium feed 9 comprises two feed channels 11 which are arranged running parallel to one another and taper onto the application region 10. On an opposite side of the feed channels from the application region 10, they are fluidically connected to a common coating medium inlet 12. The two feed channels 11 are therefore arranged in such a way that a workpiece moved along the coating unit 2 passes them successively. To this extent, coating medium may be applied sequentially to the same region of the workpiece through the two feed channels 11. The coating medium is introduced, in particular delivered, into the coating unit 2 through the coating medium inlet 12. A pump may be provided outside the coating unit 2 in order to deliver the coating medium, in particular an eccentric screw pump, a double diaphragm pump or a peristaltic pump. A pressure reservoir and/or a pulsation damper is preferably arranged in a line between the pump and the coating medium inlet 12 in order to keep the delivery flow as constant as possible.

The end of the coating medium feed 9, in particular of the feed channels 11, facing toward the application region 10 is configured as a nozzle, in particular as a flat nozzle.

In order to generate the negative pressure in the negative pressure region 8, a vacuum pump that sucks air and excess coating medium from the coating unit 2 is attached to the side represented on the right in FIGS. 3 and 4 of the housing 5.

The representations in FIGS. 3 and 4 further show a cooling channel 17 which is connected to the coolant connections 6, 7.

The representation in FIG. 5 shows a sectional representation of the blowing device 4. It may be seen that the two blowing nozzles 13 are aligned in such a way that air can be blown in the direction of the internal space of the coating unit 2, i.e. in the direction of the negative pressure region 8. The workpiece moved along the coating unit 2 passes the two blowing nozzles 13 successively. The intake opening 14 is arranged below the blowing nozzles 13 in the wall of the housing 5 and enables an additional air flow, which separates the workpiece from the negative pressure region 8 below the workpiece.

Formed inside the housing 5, starting from the air intake opening 14, there is an air intake channel 18 which extends into the internal space of the coating unit 2, particularly into the negative pressure region. In the exemplary embodiment, this air intake channel 18 together with the air intake opening 14 has a substantially L-shaped profile. An inner wall delimiting the air intake channel 18 forms a projection 19 inside the negative pressure region 8 in the housing 5. The flow profile of the air taken in from outside the coating unit 2 is defined by the air intake channel 18. The inner wall additionally shields the workpiece from the negative pressure region so that the protection against undesired suction of coating medium from the negative pressure region 8 of the coating unit 2 is further improved.

FIG. 6 shows a further exemplary embodiment of an application device 3 which may be provided as part of a coating device 2. In this exemplary embodiment, the coating medium feed 9 is arranged both above and below the negative pressure region 8.

A method for coating a portion, in particular a chamfer and/or an end face, of a planar workpiece with a coating medium may be carried out with the apparatuses 1 explained above, wherein the portion to be coated of the workpiece is moved first along the application device 3 and then along the blowing device 4 of the coating unit 2, wherein a negative pressure is generated in the negative pressure region 8 of the coating unit 2, wherein the coating medium is supplied via the coating medium feed 9 of the application device 3 to the application region 10 in which the coating medium is applied onto the portion of the workpiece by means of the negative pressure existing in the negative pressure region 8, wherein a gas, in particular air, is blown onto the workpiece through at least one blowing nozzle 13 of the blowing device 4 in order to blow applied coating medium off from the workpiece into the negative pressure region 8 and thereby to adjust a layer thickness of the coating medium on the workpiece, wherein additional air from outside the coating unit 2 flows in through the intake opening 14 of the blowing device 4 during the blowing with the blowing nozzle 13 in order to generate an air flow between the workpiece and the negative pressure region 8 and to reduce undesired deposits of coating medium on the workpiece.

### REFERENCE SIGNS

1 coating apparatus
2 coating unit
3 application device
4 blowing device
5 housing
6 coolant connection
7 coolant connection
8 negative pressure region
9 coating medium feed
10 application region
11 feed channel
12 coating medium inlet
13 blowing nozzle
14 air intake opening
15 wearing element
16 wearing element
17 cooling channel
18 air intake channel
19 projection

1. An apparatus for coating a portion of a planar workpiece with a coating medium,
having a coating unit, which comprises an application device and a blowing device that are arranged in such a way that the portion to be coated of the workpiece can be moved first along the application device and then along the blowing device,
wherein a negative pressure can be generated in a negative pressure region of the coating unit,
wherein the application device comprises a coating medium feed for supplying the coating medium to an application region in which the coating medium can be applied onto the portion of the workpiece by means of the negative pressure existing in the negative pressure region,
wherein the blowing device comprises at least one blowing nozzle through which a gas can be blown onto the workpiece in order to blow applied coating medium off from the workpiece into the negative pressure region and thereby to adjust a layer thickness of the coating medium on the workpiece,
wherein the blowing device comprises an air intake opening via which additional air from outside the coating unit can flow in during the blowing with the blowing nozzle in order to generate an air flow between the workpiece and the negative pressure region and to reduce undesired deposits of coating medium on the workpiece.

2. The apparatus as claimed in claim 1, wherein the blowing device comprises an air intake channel which extends into an internal space of the coating unit and which opens in the air intake opening.

3. The apparatus as claimed in claim 2, wherein the air intake channel forms a projection in the internal space in the negative pressure region.

4. The apparatus as claimed in claim 1, wherein the coating medium feed is arranged above the negative pressure region in the coating unit.

5. The apparatus as claimed claim 1, wherein the coating medium feed is arranged below the negative pressure region in the coating unit.

6. The apparatus as claimed in claim 1, wherein the coating medium feed comprises a plurality of feed channels which open in the application region.

7. The apparatus as claimed in claim 1, wherein the coating medium feed (comprises at least one feed channel which is formed as an upwardly open recess in the application region, the feed channel reaching as far as a front plate of the coating unit.

8. The apparatus as claimed in claim 7, wherein a plurality of feed channels are formed as upwardly open recesses in the application region, the feed channels reaching as far as a front plate of the coating unit and being arranged next to one another.

9. The apparatus as claimed in claim 1, including a transport means for transporting the workpiece along the coating unit, the transport means being adapted to move the workpiece first along the application device and then along the blowing device.

10. The apparatus as claimed in claim 1, wherein at least one wearing element, which delimits the application region, is arranged on and releasably connected to an outer contour of the coating unit.

11. The apparatus as claimed in claim 1, wherein the coating unit comprises a wall in which a cooling channel for conducting a coolant is arranged.

12. A method for coating a portion of a planar workpiece with a coating medium, comprising
moving the portion to be coated of the workpiece first along an application device and then along a blowing device of a coating unit,
generating a negative pressure in a negative pressure region of the coating unit,
supplying the coating medium via a coating medium feed of the application device to an application region in which the coating medium is applied onto the portion of the workpiece by means of the negative pressure existing in the negative pressure region,
blowing a gas onto the workpiece through at least one blowing nozzle of the blowing device in order to blow applied coating medium off from the workpiece into the negative pressure region and thereby to adjust a layer thickness of the coating medium on the workpiece,
wherein additional air from outside the coating unit flows in through an intake opening of the blowing device during the blowing with the blowing nozzle in order to generate an air flow between the workpiece and the negative pressure region and to reduce undesired deposits of coating medium on the workpiece.

13. The method as claimed in claim 12, wherein the gas is blown through the blowing nozzle onto the workpiece with a pressure in a range of from 0.05 bar to 4 bar.

14. The method as claimed in claim 12, wherein the gas is humidified before being blown out from the blowing nozzle.

15. The method as claimed in claim 12, wherein the negative pressure in the coating unit is in a range of from 10 mbar to 250 mbar.

16. The method as claimed in claim 12, wherein a temperature of the coating unit is adjusted to the dew point.

17. The method as claimed in claim 12, wherein ambient air surrounding the coating unit is humidified in such a way that the dew point lies above a minimum processing temperature of the coating medium.

18. The apparatus as claimed in claim 1, wherein the portion of the planar workpiece that is coated is a chamfer and/or an end face.

19. The apparatus as claimed in claim 10, wherein the at least one wearing element is a wearing plate.

20. The method as claimed in claim 12, wherein the portion of the planar workpiece that is coated is a chamfer and/or an end face.
